(19) United States
(12) Patent Application Publication
(10) Pub. No.: US 2014/0328641 A1
(43) Pub. Date: Nov. 6, 2014

(54) DRILL AND PRODUCTION METHOD FOR A DRILL

(71) Applicants: Carsten Peters, Sax (CH); Guenther Domani, Weissensberg (DE); Marcel Roessner, Felkirch (AT); Josef Starkmann, Hurlach (DE)

(72) Inventors: Carsten Peters, Sax (CH); Guenther Domani, Weissensberg (DE); Marcel Roessner, Felkirch (AT); Josef Starkmann, Hurlach (DE)

(73) Assignee: Hilti Aktiengesellschaft, Schaan (LI)

(21) Appl. No.: 14/353,517

(22) PCT Filed: Jul. 18, 2012
(86) PCT No.: PCT/EP2012/064078

§ 371 Date: Jun. 9, 2014

(30) Foreign Application Priority Data
Oct. 25, 2011 (DE) DE102011085187.9

(51) Int. Cl. B23B 51/02; E21B 10/44; B28D 1/14; B23P 15/32

(52) U.S. Cl. CPC B23B 51/02; B23P 15/32; E21B 10/445; B28D 1/146; B23B 2251/406; B23B 2251/408
USPC 408/226; 76/108.2

(57) ABSTRACT

A drill bit has a shank (4) between a drilling head (3) and an insertable end (5) along an axis (2). The shank (4) is provided with at least two first flutes (34) that run along the axis (2) and at least a second helical flute (31). The first flutes (34) and the second flute (31) cross each other at several crossings (41).The width (35) of the first flute 34 steadily decreases over the area between two adjacent crossings (41) from one of the crossings (41) all the way to the narrowest place (42) and subsequently steadily increases all the way to the other crossing (41).

### BACKGROUND

A spiral drill bit with additional swarf flutes running parallel to the axis is disclosed in U.S. Pat. No. 2,728,558. The additional axial swarf flutes are intended to allow a better pressure equalization inside a drilled hole during chiseling work. European patent application EP 1 621 274 A1 likewise puts forward an additional axial flute that is intended to equalize excess pressure in a drilled hole when a spiral of the drill bit has become clogged.

### SUMMARY OF THE INVENTION

The present invention provides a drill bit having a shank between the drilling head and the insertable end along an axis. The shank is provided with at least two first flutes that run along the axis and at least a second helical flute. The first flutes and the second flute cross each other at several crossings. The width of the first flute steadily decreases over the area between two adjacent crossings from one of the crossings all the way to the narrowest place. After the narrowest place, the flute width increases steadily all the way to the other crossing.

The first axial flutes also have a varying width outside of the crossings with the second, helical flutes. The varying width lends itself to reducing or even preventing swarf from flowing along the axial flutes, thus guiding the flow of swarf along the helical flutes so as to ensure an efficient removal.

The drill bit can have a multi-threaded spiral with several helical flutes; in particular, the spiral can have two or four helical flutes arranged rotationally symmetrically. In the case of more than one helical flute, the first flute alternately crosses the helical flutes, as a result of which adjacent crossings are crossings of the axial flute with various helical flutes. The number of axial flutes is not linked to the number of helical flutes. In particular, precisely two or precisely four axial flutes can be provided. The axial flutes are preferably arranged rotationally symmetrically to the axis.

One embodiment provides that the drill bit also has a plurality of helical ribs. The ribs are delimited by the first flutes in the circumferential direction and by the second flutes along the axis. The helical ribs have a convex surface in the circumferential direction. The convex surfaces narrow the axial flutes between the adjacent crossings.

One embodiment provides that the second flutes are wider than the first flutes. The average width of the first flutes is at the maximum half as large as the width of the second flutes. A first surface that is perpendicular to the course of the axial flute and that is delimited by the axial flute and by a cylindrical envelope of the shank amounts, at the maximum, to one-fourth of a second surface that is perpendicular to the course of the helical flute and that is delimited by the helical flute and by the cylindrical envelope.

One embodiment provides that the radial distance between the first flutes and the axis is equal to or less than 10% smaller than the radial distance between the second flute and the axis. The flow of the swarf experiences a turbulence in the area of the crossings, a situation that can detrimentally affect the flow behavior. A depth that is of the same magnitude or slightly deeper, preferably between 5% and 10% deeper, than the first axial flute proves to be advantageous in this context.

A production method for a drill bit comprises the following steps: a rod-like blank is formed having a cylindrical core and at least two webs that protrude radially from the cylindrical core and that run along an axis of the blank, and having first flutes that run in the circumferential direction between the webs and that expose the cylindrical core; a second helical flute that crosses the webs is rolled longitudinally into the blank. A drilling head is created on one end face of the rolled blank. The other end of the blank is machined to form an insertable end or else it is provided with an insertable end.

Conventional rolling methods for spirals are cross-rolling methods in which the blank is rolled around the axis on a rolling profile. These methods are naturally harmonized with the helical symmetry of the spirals. The described cross-rolling method breaks the high symmetry. The initial creation of the axial flutes allows the formation of virtually smooth spiral flutes. The interruptions of the helical flutes by the axial flutes have proven to be acceptable for the function of the spirals.

One embodiment provides that the rod-like blank is formed without mirror symmetry of the planes that encompass the axis. The lack of mirror symmetry has proven to be advantageous to compensate for torsional forces that occur during the rolling procedure.

### BRIEF DESCRIPTION OF THE DRAWINGS

The description below explains the invention on the basis of embodiments and figures provided by way of examples. The figures show the following:

FIG. 1: a drill bit;

FIG. 2: a longitudinal section through the shank of the drill bit in the plane II-II;

FIG. 3: a longitudinal section through the shank of the drill bit in the plane

FIG. 4: a cross section through the shank of the drill bit in the plane IV-IV;

FIG. 5: a cross section through the shank of the drill bit in the plane V-V;

FIG. 6: a cylindrical partial section through the shank;

FIG. 7 a cross section through the shank of the drill bit in the plane VII-VII;

FIG. 8: illustration of profile rolling for a rod-like blank;

FIG. 9: illustration of lengthwise rolling of a shank from the blank;

FIG. 10: section through FIG. 9 in the plane X-X.

Unless otherwise indicated, identical or functionally equivalent elements are designated by the same reference numerals in the figures.

### DETAILED DESCRIPTION

FIG. 1 shows an example of a drill bit 1, which is especially designed for chisel drilling. Along the axis 2, the drill bit 1 has three essentially consecutive functional sections, namely, a drilling head 3, a shank 4 and an insertable end 5. The insertable end 5 of the drill bit 1 can be inserted into a power tool. The power tool turns the drill bit 1, preferably continuously, around the axis 2 and strikes periodically onto an end face 6 of the insertable end 5, and this striking action is introduced into a substrate in the striking direction 7 by the drilling head 3.

The drilling head 3 has a seat 8 to which the chiseling element 9 is attached. The chiseling element 9 projects beyond the seat 8 in the striking direction 7 as well as in the radial direction in order to introduce the striking pulse and the shearing forces into the hole being drilled. The seat 8 has, for instance, the same radial dimensions as the shank 4 and, like the shank 4, it is preferably made of steel. A slit can be formed, for example, milled, into an axial end face of the seat 8. The chiseling element 9 is inserted into the slit and integrally bonded to the seat 8. In an alternative embodiment, the seat is configured as a flat end face to which the chiseling element 9 is integrally bonded.

The chiseling element 9 shown has four chiseling faces 12 facing in the striking direction 7. The chiseling faces 12 are each formed as a crossing line of a leading surface 13 as seen in the rotational direction of the drill bit 1 and of a trailing surface 14, both of which are slanted with respect to the axis 2 as well as slanted relative to each other by at least 60° . The chiseling faces 12 run essentially in the radial direction, for example, starting at a tip 15 of the chiseling element 9 all the way to an edge of the chiseling element 9, where the chiseling faces 12 are preferably set back with respect to the tip 15 in the striking direction 7. The slant of the chiseling faces 12 vis-à-vis the axis 2 can be uniform or else it can be, for instance, less in the area of the tip 15 than at the edge. In particular, the edge of the chiseling face 12 can run perpendicular to the axis 2. The chiseling element 9 shown has two pairs of chiseling faces that are configured differently, of which the pair that forms the tip 15 is referred to as the main cutters while the other pair is referred to as the secondary cutters. Instead of four chiseling faces, the chiseling element can also have two chiseling faces, for example, only the main cutters, or else three or more chiseling faces. At the edge of the chiseling element 9 and adjoining the chiseling faces 12 that face in the striking direction 7, there is a cutting face 18 running along the axis 2. The cutting face 18 protrudes radially beyond the seat 8. The circumference of the chiseling element 9 is provided with removal channels 19 which run parallel to the axis 2 and along which the swarf can be transported out of the hole that is being drilled. The removal channels 19 are located between the chiseling faces 12 in the circumferential direction. The chiseling element 9 preferably consists of a contiguous element made of sintered hard metal that contains, for instance, tungsten carbide and a metal binder.

The insertable end 5 shown is specially designed for a rotating-chiseling drill bit 1. The essentially cylindrical section at the end of the drill bit 1 has a diameter that corresponds to that of the fixed inner diameter of the socket of commercially available power tools. The sockets can have webs or bolts which serve to improve the torque transmission and which engage with matching flutes 20 for purposes of rotationally driving the insertable end 5. The axially open flutes 117 are open opposite to the striking direction 7 in that they extend all the way to the end face 6 of the drill bit. The insertable end 5 of the drill bit 1 is locked in the socket by means of additional flutes 21 that are axially closed along the axis 2. Other drill bits 1 can have a purely cylindrical insertable end without flutes or an insertable end with protruding webs instead of the rotationally driving flutes.

The drilling head 3 and the insertable end 5 are rigidly joined by means of the shank 4. The shank 4 transmits a torque from the insertable end 5 onto the drilling head 3 and optionally also an axial pulse from the insertable end 5 onto the drilling head 3. The drilling head 3 can be inserted into a drilled hole for the length (dimension along the axis 2) of the shank 4. Advantageously, the shank 4 is several times longer than the drilling head 3.

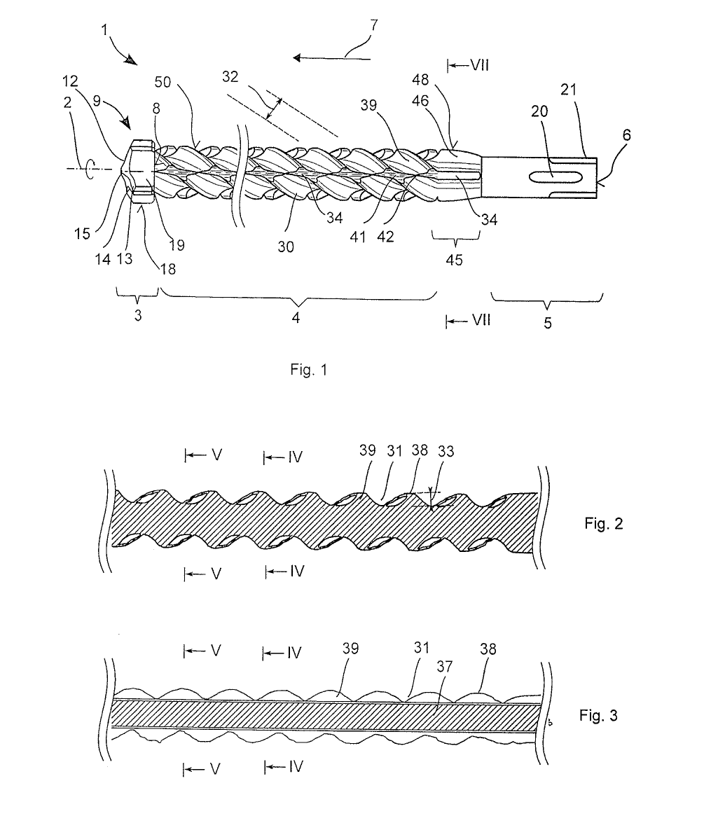

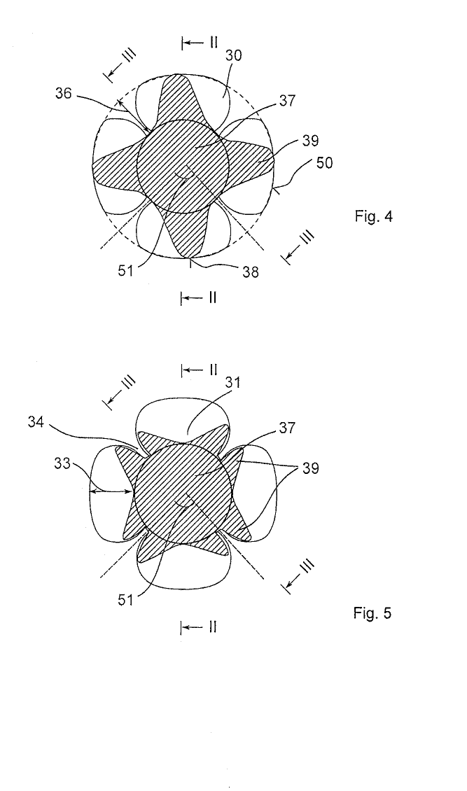

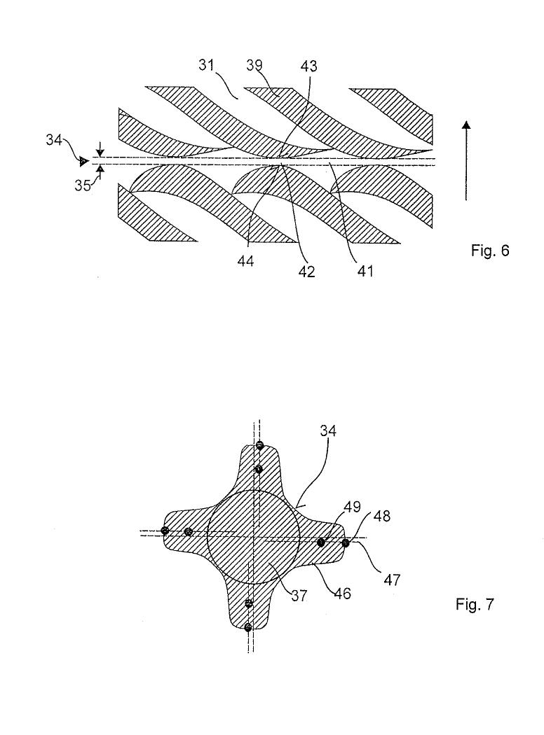

The shank 4 is illustrated in several sectional views. FIG. 2 shows a longitudinal section in the plane II-II, FIG. 3 shows a longitudinal section in the plane which is rotated by 45° vis-à-vis the plane II-II, FIG. 4 shows a cross section in the plane IV-IV, FIG. 5 shows a cross section in the plane V-V, and FIG. 7 shows a cross section in the plane VII-VII. FIG. 6 shows a small section of the shank at a constant distance from the axis 2.

The shank 4 has four flights 30 of the spiral that serve to remove the swarf from the drilled hole. The shank 4 shown by way of an example has a four-fold rotational symmetry that is predefined by the four flights 30 of the spiral. Helical flutes 31 of the flights 30 of the spiral run continuously like a screw or spiral around the shank 4. A cross section profile of the helical flutes 31 is, for example, in the form of a semi-circle or a circle segment. The lead or pitch of the helical threads is preferably constant and, in another embodiment, it can vary continuously along the axis 2. The flutes 31 extend all the way to the drilling head 3 and preferably make a smooth transition into the removal channels 19 of the drilling head 3. The flute width 32, measured perpendicularly to the helical course of the flute 31, and the flute depth 33, measured in the radial direction, are appropriately dimensioned to transport the swarf. The number of flights 30 of the spiral is given by way of an example and is preferably selected so as to match the number of chiseling faces 12.

Four additional flutes that run parallel to the axis 2 (axial flutes) are created in the shank 4. The axial flutes 34 run at least over the entire axial length of the helical flutes 31. For example, the axial flutes 34 start at the drilling head 3 and extend along the axis 2 further than the helical flutes 30. The helical flutes 31 and the axial flutes 34 cross each other several times over the length of the shank 4. The width 35 of the flutes 34 is considerably smaller than the width 32 of the helical flutes 31, for instance, by one-half of the opening angle at the maximum. In particular, a volume delimited by a drilled hole and the helical flutes 31 is much greater than a corresponding volume delimited by the axial flutes 34. The axial flutes 34 do not have any influence on the removal of the swarf through the helical flutes 31. The depth 36 of the axial flutes 34 is about equal to or less than 10% greater than the depth 33 of the helical flutes 31. The course of the helical flutes 31 is only minimally affected by the axial flutes 34, in particular, it is not affected by local crosswise elevations present at the bottom of the flutes nor by deep local crosswise grooves that could hinder the removal of the swarf. The bottom of the axial flutes 34 preferably exposes a cylindrical core 37 of the shank 4.

The flights 30 of the spiral do not have any contiguous spines 38 but rather, the spines 38 of the spiral are interrupted by the axial flutes 34 that each consist of several ribs 39. The ribs 39 of a spine 38 of the spiral are arranged along a spiral-shaped line, that is to say, along the spine 38 of the spiral on the cylindrical core 37 of the shank 4. The ribs 39 are delimited along the axis 2 by the adjacent helical flutes 30 and are therefore slanted with respect to the axis 2. In the circumferential direction, the ribs 39 are delimited by axial flutes 34 that are adjacent in the circumferential direction. The axial flutes 34 have a wavy edge, as a result of which the width 35 of the axial flutes 34 along the axis 2 is modulated without having any edges. In particular, no edges are formed, but rather smooth transitions at the crossings 41 of the helical flutes 31 and of the axial flutes 34. The axial flute 34 displays its greatest width adjacent to the crossings 41. In the area between two crossings 41, the flute width decreases starting at the first of the crossings 41 until the narrowest place 42 is reached, and after the narrowest place 42, it increases all the way to the second crossing 41. The flute width 35 increases or decreases steadily, that is to say, not in steps. Moreover, the change between the narrowest place 42 and the crossings 41 is uniform, that is to say, the axial flute 34 does not become locally wider again. The leading surfaces 43 as seen in the rotational direction and the trailing surfaces 44—as seen in the rotational direction—of the ribs 39 that delimit the axial flute 34 in the circumferential direction are smooth and arched, whereby the arches face in the direction of the opposite surfaces 43, 44 of the adjacent rib 39.

The leading surfaces 43 and the trailing surfaces 44 of the ribs 39 can be curved to differing degrees and, in particular, the trailing surface 44 can have a smaller radius of curvature. For this reason, the axial flutes 34 can be configured so as to be asymmetrical and, in comparison to the area having the smallest flute width, they can expand more markedly in the rotational direction of the spiral than opposite from the rotational direction.

Another asymmetry is found in the starting area 45 of the axial flutes 34, where no helical flutes 31 have been created. Radially protruding webs 46 are formed between the axial flutes 34. A plane 47 running through the spines 48 of the webs 46 and their center of mass 49 is parallel but offset relative to the axis 2.

The ribs 39 of the spirals each have a spiral-shaped vertex 50 running along the highest points. The vertex 50 is the boundary line from where the surface of the rib 39 approaches the axis 2 in both directions parallel to the axis 2. The vertex 50 can be in contact with a cylinder that encloses the shank 4 over an angular range 51 of 80° at the maximum and preferably at least 30°, for instance, at least 45°. A radius of curvature that is on a vertex 50 that is projected perpendicular to the axis 2 is of the same magnitude as the largest radial distance from the vertex 50 to the axis 2 within this angular range 51.

In another embodiment, the axial flutes 34 can run around the shank 4 slightly spiral-like, whereby the axial flutes preferably wind around the shank 4 one time at the maximum. The number of windings of the axial flutes 34 is smaller by one order of magnitude than the number of windings of the helical flutes 31. Preferably, the rotational direction of the axial flutes is opposite to the rotational direction of the helical flutes 31.

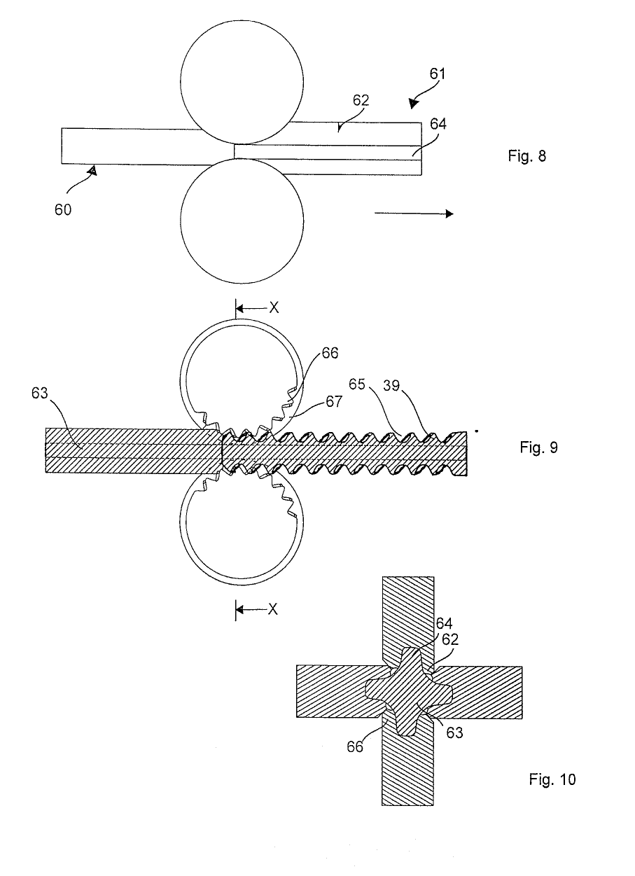

A production method of the drill bit 1 is described by way of an example below making reference to FIGS. 8 and 9, while FIG. 10 shows a section in the plane X-X. For example, a cylindrical rod 60 is cut out of a continuous wire, whereby the length of said rod corresponds approximately to the length of the drill bit 1 that is to be manufactured. A cross sectional surface of the rod is approximately equal to a center cross sectional surface of the spiral that is to be made.

A first rolling method serves to form the cylindrical rod 60 into a non-cylindrical prismatic blank 61. The rollers press into the cylindrical rod to form four flutes 62 that run along the axis 2. The flutes 62 preferably have the same shape and are arranged offset relative to each other by 90° around the axis 2. Consequently, the resulting blank 61 has a four-fold rotational symmetry that corresponds to the rotational symmetry of the spirals that are to be made. The blank 61 has a cylindrical core 63 that extends along the axis 2 and that is exposed in the area of the flutes 62. Four webs 64 that run along the axis 2 are formed so as to extend radially from the cylindrical core 63. The blank 61 is preferably not mirror-symmetrical to any plane that encompasses the axis 2. For instance, the webs 64 can be slanted with respect to the cylindrical core 63. The first rolling method can be a cross-rolling method, that is to say, the roller profiles roll along the circumferential direction of the rod, or else a longitudinal rolling method, in other words, the roller profiles roll along the axis. As an alternative to a rolling method, the profile can also be formed by means of extrusion molding.

A second rolling method forms helical flutes 65 into the web 64. In the case of the longitudinal rolling method employed here, rolling profiles are rolled along the axis 2 on the blank 61. All in all, four rolling profiles 66 are employed, each of which forms precisely one of the webs 64 into consecutive helical ribs 39 along the axis 2. The rolling profile locally encloses the rib 64, and its outer flanks 67 engage into flutes 62 that are adjacent to the web 64. The flanks 67 of the four rolling profiles touch each other inside the flute 62 and form a closed ring around the blank 61. The flanks 67 preferably do not extend all the way to the bottom of the flutes 62.

One end face of the formed blank having the ribs 39 is provided with the seat for the drilling head 3. The end face can be milled, for instance, to form a flat surface. The drilling head 3 is integrally bonded and optionally positively attached to the seat. The insertable end 5 is formed on the opposite end of the blank, for example, by rolling or milling the flutes.

1-6. (canceled)

7. A drill bit comprising:
a shank between a drilling head and an insertable end along an axis, the shank having at least two first flutes running along the axis and at least a second helical flute, the first flutes and the second flute crossing each other at several crossings, a width of the first flutes steadily decreasing over an area between two adjacent crossings from one of the crossings all the way to a narrowest place and subsequently steadily increasing all the way to the other crossing.

8. The drill bit as recited in claim 7 wherein a plurality of helical ribs are delimited by the first flutes in the circumferential direction and by the second flutes along the axis, and the helical ribs have a convex surface in the circumferential direction.

9. The drill bit as recited in claim 7 wherein the second flutes are wider than the first flutes.

10. The drill bit as recited in claim 7 wherein a radial distance between the first flutes and the axis is equal to or less than 30% smaller than the radial distance between the second flute and the axis.

11. A production method for a drill bit comprising the following steps:
forming a rod-like blank having a cylindrical core and at least two webs protruding radially from the cylindrical core and running along an axis of the blank, and having first flutes running in the circumferential direction between the webs and exposing the cylindrical core; and
rolling longitudinally a second helical flute crossing the webs into the blank; and
creating a drilling head on one end face of the blank.

12. The production method as recited in claim 11 wherein the rod-like blank is formed without mirror symmetry of planes encompassing the axis.
